(19) United States
(12) Patent Application Publication
(10) Pub. No.: US 2010/0119986 A1
(43) Pub. Date: May 13, 2010

(54) MULTIPLE HEARTH FURNACE

(75) Inventors: Emile Lonardi, Bascharage (LU); Patrick Hutmacher, Bettembourg (LU); Edgar Kraemer, Hellange (LU); Paul Tockert, Luxembourg (LU)

Correspondence Address: CANTOR COLBURN, LLP, 20 Church Street, 22nd Floor, Hartford, CT, 06103, US

(73) Assignee: PAUL WURTH S.A., LUXEMBOURG (LU)

(21) Appl. No.: 12/527,093

(22) PCT Filed: Jan. 31, 2008
(86) PCT No.: PCT/EP08/51171

§ 371 Date: Aug. 13, 2009

(30) Foreign Application Priority Data
Feb. 16, 2007 (LU) 91311

(51) Int. Cl. F27B 1/02; F27B 1/24; F27D 9/00

(52) U.S. Cl. 432/95; 432/98; 432/235

(57) ABSTRACT

A multiple hearth furnace includes a gas cooling system for its central shaft and its rabble arms. This gas cooling system includes within the shaft an annular main distribution channel for supplying a cooling gas to the rabble arms and a central exhaust channel for evacuating the cooling gas leaving the rabble arms. The gas cooling system further includes an annular main supply channel surrounding the annular main distribution channel and being outwardly delimited by an outer shell of the shaft. A cooling gas inlet is connected to the annular main supply channel. A cooling gas passage between the annular main supply channel and the annular main distribution channel is spaced from the cooling gas inlet, so that cooling gas supplied to the cooling gas inlet has to flow through the annular main supply channel through several hearth chambers before it flows through the cooling gas passage into the annular main distribution channel.

### TECHNICAL FIELD OF THE INVENTION

The present invention generally relates to a multiple hearth furnace (MHF).

### BRIEF DESCRIPTION OF RELATED ART

Multiple hearth furnaces (MHFs) have been used now for about one century for heating or roasting many types of material. They comprise a plurality of hearth chambers arranged one on top of the other. Each of these hearth chambers comprises a circular hearth having alternately a central material drop hole or a plurality of peripheral material drop holes therein. A vertical rotary shaft extends centrally through all these superposed hearth chambers and has in each of them a rabble arm fixing node. Rabble arms are connected in a cantilever fashion to such a rabble fixing node (normally there are two to four rabble arms per hearth chamber). Each rabble arm comprises a plurality of rabble teeth extending downwards into the material on the hearth. When the vertical rotary shaft is rotated, the rabble arms plough material on the hearth with their rabble teeth either towards the central drop hole or towards the peripheral drop holes in the hearth. Thus, material charged into the uppermost hearth chamber is caused to move slowly downwards through all successive hearth chambers, being pushed by the rotating rabble arms over the successive hearths alternately from the periphery to the center (on a hearth with a central material drop hole) and from the center to the periphery (on a hearth with peripheral material drop holes). Arrived in the lowermost hearth chamber, the roasted or heated material leaves the MHF through a furnace discharging opening.

It will be appreciated that the vertical rotary shaft and the rabble arms are not only subjected to severe mechanical stresses, but they also have to withstand high temperatures and very corrosive atmospheres. Consequently, it is particularly important to warrant that structural rigidity of these elements is not affected by overheating, and that high temperature corrosion (in particular accelerated chloride corrosion due to overheating) as well as low temperature corrosion (in particular corrosion due to acid condensation as a direct consequence of overcooling) are reliably avoided. Furthermore, non-uniform temperature distributions may result in mechanical stresses causing deformations or even mechanical ruin of the shaft or the rabble arms.

In documents describing very early multiple hearth furnaces it is sometimes mentioned that rabble arms may either be water or gas cooled. Nevertheless, operating hearth furnaces exclusively include—as far as applicants know—gas cooled rabble arms. Indeed, if there is a leakage in a water cooled rabble arm, the whole furnace has to be shut down in order to find and repair the leakage, whereas a leakage in a gas cooled rabble arm does not necessarily require a direct intervention. However, gas cooled MHFs have serious drawbacks too. For example, a gas cooling circuit is not always capable of warranting a precise control of surface temperature. It follows that some surfaces of the vertical rotary shaft or the rabble arms or may be overheated or overcooled, which leads to the drawbacks mentioned above.

In most MHFs, the vertical rotary shaft as well as the rabble arms are tubular structures that are cooled by a gaseous cooling fluid, generally pressurized ambient air. (For the sake of simplicity, the gaseous cooling fluid will be called herein “cooling gas”, even if it may be a mixture of several gases, such as e.g. air). The vertical rotary shaft includes a cooling gas distribution channel for supplying the cooling gas to the rabble arms. From this cooling gas distribution channel, the cooling gas is channeled through the connection between the rabble arm and the rabble arm fixing node into the tubular structure of the rabble arm. As the cooling system of the rabble arm is normally a closed system, the cooling gas returning from the rabble arm must be channeled through the connection between the rabble arm and the rabble arm fixing node into an exhaust gas channel in the vertical rotary shaft.

In the last hundred years, there have been described various embodiments of such gas-cooled vertical rotary shafts and cantilever rabble arms for a MHF. For example:

U.S. Pat. No. 1,468,216 discloses a vertical hollow shaft of a MHF, in which a central partition wall separates a cooling gas distribution duct from an exhaust duct, each of them having a semicircular cross-section. In each hearth chamber, a cooling gas flow is branched off from the cooling gas flow in the cooling gas distribution duct to be rerouted through a rabble arm cooling system and to be thereafter evacuated into the exhaust duct. It follows that in the cooling gas distribution duct the flow rate and, consequently, the velocity of the gas strongly diminish from the bottom to the top and in the exhaust duct strongly they strongly increase from the bottom to the top. This results in a very un-uniform cooling of the vertical rotary shaft as well in a lengthwise as in a circumferential direction.

U.S. Pat. No. 3,419,254 discloses a double-shell gas-cooled vertical rotary shaft. The central space within the interior shell constitutes an intake duct and the annular space between the outer shell and the inner shell an exhaust duct. While this system warrants a more uniform cooling of the vertical rotary shaft in a circumferential direction of the shaft, cooling in the lengthwise direction of the shaft is still very uniform.

U.S. Pat. No. 2,332,387 also discloses a double-shell gas-cooled vertical rotary shaft. In this shaft, the annular space between the outer shell and the inner shell constitutes an intake duct and the central space within the interior shell an exhaust duct. The outer shell is—except at the rabble arm supports—of substantially the same diameter from the bottom to the top. In order to have a more uniform cooling gas flow within both ducts, U.S. Pat. No. 2,332,387 teaches to increase the diameter of the interior shell from the bottom to the top. A first disadvantage of this system is that the cooling gas strongly heats up from the bottom to the top of the annular intake duct, which results in a poorer cooling of the shaft and the rabble arms in the upper hearth chambers. A further disadvantage of this system is that the geometry of the shaft must be different in each hearth chamber, which makes its manufacturing of course more expensive.

### BRIEF SUMMARY OF THE INVENTION

The invention provides a MHF with a more uniform gas cooling of the shaft and the rabble arms.

More particularly, the present invention proposes a multiple hearth furnace comprising, in a manner known per se: a plurality of hearth chambers arranged one on top of the other; a hollow vertical rotary shaft extending centrally through the hearth chambers and including an outer shell; in each of the hearth chambers, at least one rabble arm secured to the shaft; a gas cooling system for the shaft and the rabble arms including, within the outer shell, an annular main distribution channel for supplying a cooling gas to the rabble arms and a central exhaust channel for evacuating the cooling gas leaving the rabble arms; and a connecting means for connecting the rabble arms to the shaft including cooling gas supply means in direct communication with the annular main distribution channel and cooling gas return means in direct communication with the central exhaust channel. In accordance with the present invention, the gas cooling system further comprises an annular main supply channel surrounding the annular main distribution channel and being outwardly delimited by the outer shell. A cooling gas inlet is connected to the annular main supply channel. A cooling gas passage between the annular main supply channel and the annular main distribution channel is spaced from the cooling gas inlet, so that cooling gas supplied to the cooling gas inlet has to flow through the annular main supply channel through several hearth chambers before it flows through the cooling gas passage into the annular main distribution channel. It will be appreciated that with such a system, the whole main supply flow of cooling gas is first used to provide an efficient and uniform cooling of the outer shell of the vertical rotary shaft in several hearth chambers. The constant, high flow rate in the annular main supply channel warrants a relatively small temperature increase of the cooling gas between the cooling gas inlet and the cooling gas passage in the annular main distribution channel. In this inner annular distribution channel, the flow of the cooling gas—which now diminishes from hearth chamber to hearth chamber—is relatively well protected against additional warming up, so that the rabble arms in all superposed hearth chambers are supplied with a cooling gas at substantially the same temperature. All this results in a very efficient and uniform cooling of the shaft and the rabble arms.

The gas cooling system can e.g. comprise a single cooling gas inlet connected either to the lower or to the upper end of the vertical rotary shaft, i.e. the cooling gas supplied to the cooling gas inlet has to flow through the annular main supply channel through all hearth chambers before it flows through the cooling gas passage into the annular main distribution channel. However, in a preferred embodiment, the gas cooling system further comprises partition means partitioning the annular main supply channel and the annular main distribution channel in a lower half and an upper half. A lower cooling gas inlet is then connected to the lower half of the annular main supply channel at the lower end of the shaft, and an upper cooling gas inlet is connected to the upper half of the annular main supply channel at the upper end of the shaft. A lower cooling gas passage is arranged between the lower half of the annular main supply channel and the lower half of the annular main distribution channel and located near the partition means, so that cooling gas supplied to the lower cooling gas inlet has to flow upwards though the lower half of the annular main supply channel up to the partition means before it can flow through the lower cooling gas passage into the lower half of the annular main distribution channel. An upper cooling gas passage is arranged between the upper half of the annular main supply channel and the upper half of the annular main distribution channel and located near the partition means, so that cooling gas supplied to the upper cooling gas inlet has to flow downwards though the upper half of the annular main supply channel down to the partition means before it can flow through the second cooling gas passage into the upper half of the annular main distribution channel. It will be appreciated that this system results in a further improvement of the cooling system of the shaft and the rabble arms. With this split system, it is e.g. easier to equilibrate gas supply for the rabble arms in the superposed hearth chambers.

A preferred embodiment of the outer shell comprises: shaft support tubes and cast rabble arm fixing nodes interconnecting the shaft support tubes, wherein at least one rabble is fixed to each of the rabble arm fixing nodes. In this shaft, the rabble arm fixing node and the shaft support tubes are advantageously welded together. The shaft support tubes are advantageously made of thick walled stainless steel tubes and are dimensioned as structural load carrying members between the rabble arm fixing nodes. It will be appreciated that such a shaft can be easily manufactured at relatively low costs using standardized elements. It provides however a strong, long-lasting support structure that has a very good resistance with regard to temperature and corrosive agents in the hearth chambers.

A preferred embodiment of a rabble arm fixing nodes advantageously comprises a ring-shaped cast body made of refractory steel. It will be appreciated that such a rabble arm fixing node is a particularly compact, strong and reliable connection means for connecting the rabble arm to the vertical rotary shaft.

A preferred embodiment of a rabble arm rabble arm includes a tubular structure for circulating therethrough a cooling gas and plug body connected to the tubular structure of the rabble arm received in a socket on the vertical rotary shaft. It will be appreciated that such a plug body, which can be manufactured without necessitating complicated casting moulds, is a particularly compact, strong and reliable connection means for connecting the rabble arm to the vertical rotary shaft.

A further preferred embodiment of a rabble arm fixing nodes comprises a ring-shaped cast body including: at least one socket for receiving therein the plug body of the rabble arm. A central passage forms the central exhaust channel for the cooling gas within the rabble arm fixing node. First secondary passages are arranged in a first ring section of the cast body, so as to provide gas passages for cooling gas flowing through the annular main distribution channel. Second secondary passages are arranged in a second ring section of the cast body, so as to provide gas passages for cooling gas flowing through the annular main supply channel. The cooling gas supply means is arranged in the cast body so as to interconnect the annular internal supply channel for the cooling gas with at least one gas outlet opening within the socket and advantageously comprises at least one oblique bore extending through the ring-shaped cast body from the second ring section into a lateral surface delimiting the socket. The cooling gas return means is arranged in the cast body so as to interconnect the central passage with at least one gas inlet opening within the socket and advantageously comprises a through hole in axial extension of the socket. This embodiment of an arm fixing node combines a low pressure drop cooling gas distribution in the shaft and a solid fixing of the rabble arm on the shaft with a very compact and cost saving design. With its integrated gas passages, it substantially contributes to the fact that the vertical rotary shaft, which includes three co-axial cooling channels therein, can be manufactured using a very small number of standardized elements. It also essentially contributes to warranting a strong, long-lasting shaft support structure with a very good resistance with regard to temperature and corrosive agents in the hearth chambers.

In a preferred embodiment, a section of the shaft extending between two adjacent hearth chambers comprises: a shaft support tube arranged between two arm fixing nodes to form the outer shell of the section of the shaft, the shaft support tube delimiting the annular main supply channel to the outside; an intermediate gas guiding jacket arranged within the shaft support tube so as to delimit the annular main supply channel to the inside and the annular main distribution channel to the outside; and an inner gas guiding jacket arranged within the intermediate gas guiding jacket so as to delimit the annular main distribution channel to the inside and the central exhaust channel to the outside. In this preferred embodiment, the intermediate gas guiding jacket advantageously comprises: a first tube section with a first end fixed to the first fixing node and a free second end; a second tube section with a first end fixed to the second fixing node and a free second end; a sealing means providing a sealed connection between the free second end of the first tube section and the free second end of the second tube section, while tolerating relative movement in the axial direction of both free second ends. Similarly, the inner gas guiding jacket advantageously comprises: a first tube section with a first end fixed to the first fixing node and a free second end; a second tube section with a first end fixed to the second fixing node and a free second end; a sealing means providing a sealed connection between the free second end of the first tube section and the free second end of the second tube section, while tolerating relative movement in the axial direction of both free second ends. The sealing means advantageously comprises a sealing sleeve fixed to the free second end of one of the first or second tube sections and engaging in a sealed manner the free second end of the other tube section. It will be appreciated that such a shaft section can be easily manufactured at relatively low costs using standardized elements.

The rotary hollow shaft further advantageously comprises: an outer thermal insulation on its outer shell, the outer thermal insulation including an inner refractory layer of micro porous material, an intermediate refractory layer of insulating castable material and an outer refractory layer of dense castable material.

A preferred embodiment of a rabble arm advantageously comprises: an plug body for fixing the rabble arm to the rotary hollow shaft; an arm support tube fixed to the plug body; and a gas guiding tube arranged inside the arm support tube and cooperating with the latter to define between them a small annular gap for channeling the cooling gas from the shaft to the free end of the rabble arm, wherein the interior section of the gas guiding tube forms a return channel for the cooling gas from the free end of the rabble arm to the shaft. In this embodiment, the plug body is advantageously a solid cast body including at least one cooling gas supply channel and at least one cooling gas return channel. The at least one cooling gas supply channel and the at least one cooling gas return channel are then advantageously provided as bores in the solid cast body.

Such a rabble arm further advantageously comprises: an arm supporting tube; a micro porous thermal insulation layer arranged on the arm supporting tube; and a metallic protecting jacket covering the micro porous thermal insulation. In a preferred embodiment, metallic rabble teeth fixed to the metallic protecting jacket by welding, wherein anti-rotation means are arranged between the arm supporting tube and the metallic protecting jacket.

### BRIEF DESCRIPTION OF THE DRAWINGS

Further details and advantages of the present invention will be apparent from the following detailed description of a preferred but not limiting embodiment with reference to the attached drawings, wherein:

FIG. 1 is three dimensional view of a multiple hearth furnace in accordance with the invention, with a partial section;

FIG. 2 is schematic diagram illustrating the flow of cooling gas through the rotary hollow shaft and the rabble arms.

FIG. 3 is a section through a rotary hollow shaft, drawn as a three dimensional view;

FIG. 4 is three dimensional view of a rabble arm fixing node, with four rabble arms fixed thereto;

FIG. 5 is a first section through a socket in a rabble arm fixing node with a plug body of a rabble arm received therein (the section is drawn as a three dimensional view);

FIG. 6 is a second section through a socket in a rabble arm fixing node with a plug body of a rabble arm received therein (the section is drawn as a three dimensional view);

FIG. 7 is a section through a free end of a rabble arm (the section is drawn as a three dimensional view).

### DETAILED DESCRIPTION OF THE INVENTION

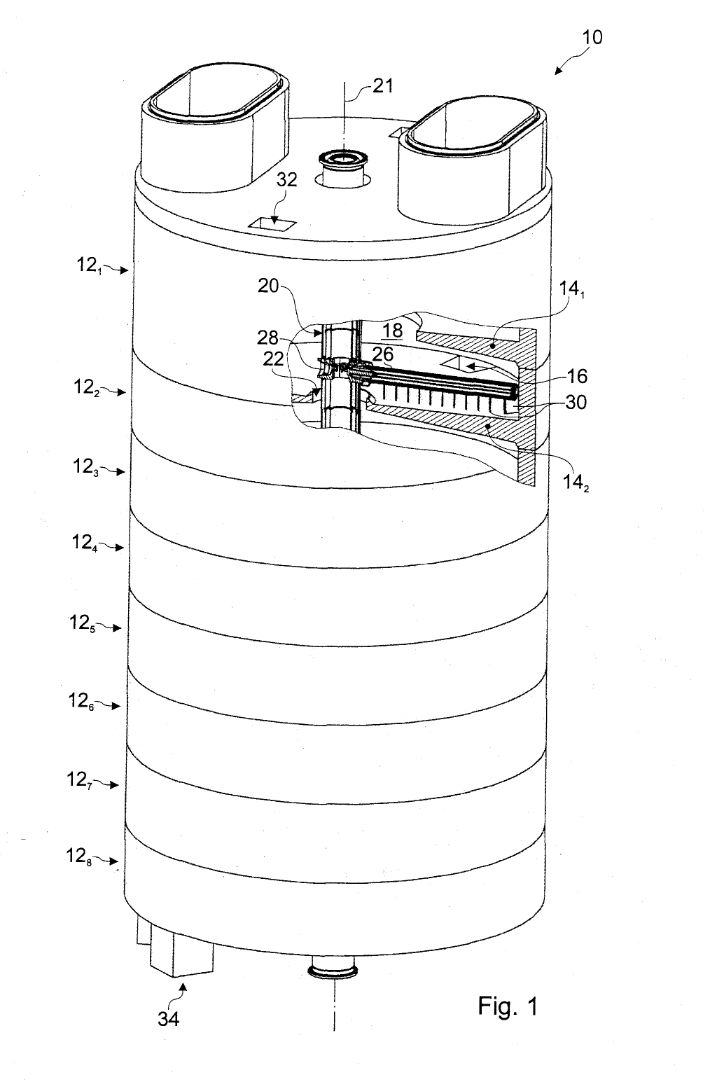

FIG. 1 shows a multiple hearth or roasting furnace 10. Both the construction and operation of such a multiple hearth furnace (MHF) 10 are known in the art and are therefore described herein only as far as they are relevant for the illustration of the inventions claimed herein.

The MHF as shown in FIG. 1 is basically a furnace including several hearth chambers 12 arranged one on top of the other. The MHF shown in FIG. 1 includes e.g. eight hearth chambers numbered 12₁, 12₂ . . . 12₈. Each hearth chamber 12 includes a substantially circular hearth 14 (see e.g. 14₁, 14₂). These hearths 14 alternately have either several peripheral material drop holes 16 along their outer periphery, such as e.g. hearth 14₂, or a central material drop hole 18, such as e.g. hearth 14₁.

Reference number 20 identifies a vertical rotary hollow shaft coaxially arranged with the central axis 21 of the furnace 10. This shaft 20 passes through all hearth chambers 12, wherein a hearth without central material drop hole 18—such as e.g. hearth 14₂ in FIG. 1—has a central shaft passage opening 22 to allow the shaft 20 to freely extend therethrough. In a hearth with a central material drop hole 18—such as e.g. hearth 14₁ in FIG. 1—the shaft 20 extends through the central material drop hole 18. It will be noted in this context that the central material drop hole 18 has a much bigger diameter than the shaft 20, so that the central material drop hole 18 is indeed an annular opening around the shaft 20.

Both ends of the shaft 20 comprise a shaft end with a journal rotatably supported in a bearing (not shown in FIG. 1). Rotation of the shaft 20 about its central axis 21 is accomplished by means of a rotary drive unit (not shown in FIG. 1). As such a rotary drive unit for the shaft 20 as well as shaft bearings are known in the art and furthermore not relevant for the understanding of the inventions claimed herein, they will not be described with greater detail hereinafter.

FIG. 1 also shows a rabble arm 26 that is secured in hearth chamber 12₂ to a rabble arm fixing node 28 on the shaft 20. Such an arm fixing node 28 is principally arranged in every hearth chamber 12, wherein it normally supports more than one rabble arm 26. In most MHFs, such an arm fixing node 28 normally supports four rabble arms 26, wherein the angle between two successive rabble arms 26 is 90°. Each rabble arm 26 includes a plurality of rabble teeth 30. These rabble teeth 30 are designed and arranged so as to move material on the hearth either towards its center or towards its periphery when the shaft 20 is rotated. In a hearth chamber with peripheral material drop holes 16 in its hearth 14, such as e.g. hearth chamber 12₂, these rabble teeth 30 are designed and arranged so as to move material on the hearth 14 towards the peripheral material drop holes 16 when the shaft 20 is rotated. In a hearth chamber with a central material drop hole 18 in its hearth 14, such as e.g. hearth chamber 12₁, these rabble teeth 30 are however designed and arranged so as to move the material on the hearth 14 towards the central material drop hole 18 when the shaft 20 is rotated in the same direction.

Now follows a brief description of material flow through the MHF 10. In order to heat or roast material within the MHF 10, this material is discharged from a conveying system (not shown) through a furnace charging openings 32 into the uppermost hearth chamber 12₁ of the MHF. In this chamber 12₁ material falls onto the hearth 14₁, which has a central material drop hole 18. As the shaft 20 is continuously rotated, the four of rabble arms 26 in the hearth chamber 12₁ push the material with their rabble teeth 30 over the hearth 14₁ towards and into its central material drop hole 18. Through the latter material falls onto the hearth 14₂ of the next hearth chamber 12₂. Here, the rabble arms 26 push the material with their rabble teeth 30 over the hearth 14₂ towards and into its peripheral material drop holes 16. Through the latter, material falls onto the next hearth (not shown in FIG. 1) that has again a central material drop hole 18. In this way, material entering the MHF 10 through the furnace charging opening 32 is passed over all eight hearths 14₁ . . . 14₈ by the rotating the rabble arms 26. Arrived in the lowermost hearth chamber 12₈, the roasted or heated material finally leaves the MHF 10 through a furnace discharging opening 34.

As known in the art, both the shaft 20 and the rabble arms 26 have internal channels through which is circulated a gaseous cooling fluid, usually pressurized air, which will be called hereinafter for the sake of simplicity “cooling gas”. The object of this gas cooling is to protect the shaft 20 and the rabble arms 26 against damage due to the elevated temperatures in the hearth chambers 12. Indeed, in the hearth chambers 12 ambient temperature may be as high as 1000° C.

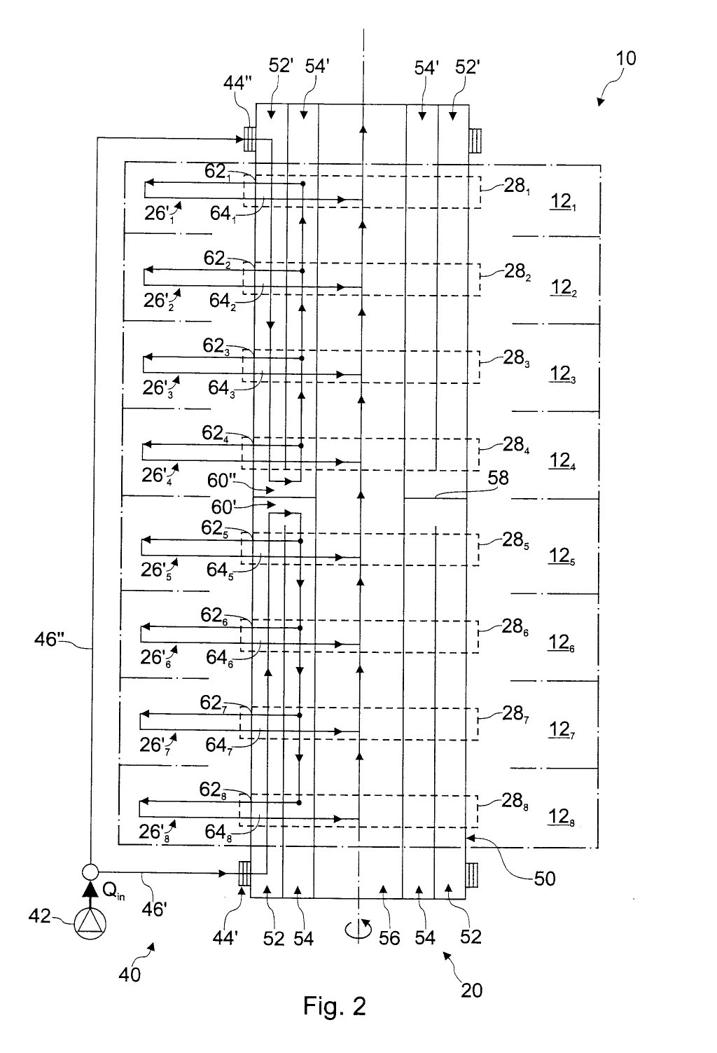

The flow diagram of FIG. 2 gives a schematic overview of a new and particularly advantageous gas cooling system 40 for the shaft 20 and the rabble arms 26. The big dashed rectangle 10 schematically represents the MFH 10 with its eight hearth chambers 12₁ . . . 12₈. A schematic representation of the rotary hollow shaft 20 illustrates the flow paths of the cooling gas within the shaft 20. Reference numbers 26′₁ . . . 26′₈ identify in each hearth chamber 12₁ . . . 12₈, a schematic representation of the cooling system of a rabble arm arranged in the respective hearth chamber. The small dashed rectangles 28₁ . . . 28₈ are schematic representations of the rabble arm fixing nodes in the shaft 20.

Reference number 42 in FIG. 2 identifies a cooling gas supply source, e.g. a fan pressurizing ambient air. As is know in the art, the fan 42 is connected by means of a lower cooling gas supply line 46′ to a lower cooling gas inlet 44′ of the shaft 20. This lower cooling gas inlet 44′ is arranged outside the furnace 10 below of the lowermost hearth chamber 12₈. However, in the MHF of FIG. 2, the fan 42 is also connected by means of an upper cooling gas supply line 46″ to an upper cooling gas inlet 44″ of the shaft 20. This upper cooling gas inlet 44″ is arranged outside the furnace 10 above the uppermost hearth chamber 12₁. It follows that the flow rate from the fan 42 is split between the lower cooling gas inlet 44′, to be supplied to lower half of the shaft 20, and the upper cooling gas inlet 44″, to be supplied to upper half of the shaft 20. It remains to be noted that—as the shaft 20 is a rotary shaft—both cooling gas inlets 44′ and 44″ must be rotary connections. As such rotary connections are known in the art and as their design is furthermore not relevant for the understanding of the inventions claimed herein, the design of the upper and lower cooling gas inlets 44′, 44″will not be described with greater detail hereinafter.

The shaft 20 includes three concentric cooling gas channels within an outer shell 50. The outermost channel is an annular main cooling gas supply channel 52 in direct contact with the outer shell 50 of the shaft 20. This annular main supply channel 52 surrounds an annular main distribution channel 54, which finally surrounds a central exhaust channel 56.

It will be noted that between hearth chambers 12₄ and 12₅, i.e. approximately in the middle of the shaft 20, a partition means, as e.g. a partition flange 58, partitions the annular main supply channel 52 and the annular main distribution channel 54 in a lower half and an upper half. This partitioning does however not affect the central exhaust channel 56, which extends from the lowermost hearth chamber 12₈ through all hearth chambers 12₈ to 12₁ to the top of the shaft 20. If it is necessary hereinafter to make a distinction between the lower and upper half of the annular main supply channel 52, respectively between the lower and upper half of the annular main distribution channel 52, the lower half will be identified with the superscript (′) and the upper half with the superscript (″)

The lower cooling gas inlet 44′ is directly connected to the lower half 52′ of the annular main supply channel 52. The cooling gas supplied to the lower cooling gas inlet 44′ consequently enters beneath the lowermost hearth chamber 12₈ into the lower annular main supply channel 52′ and is then channeled through the latter up to the partition flange 58 between hearth chambers 12₅ and 12₄, wherein the flow rate of the cooling gas remains unchanged over the whole length of the lower annular main supply channel 52′. This constant flow rate of cooling gas over the whole length of the lower annular main supply channel 52′ warrants that the outer shell 50 of the shaft 20 is efficiently cooled in the four lower hearth chambers 12₈ . . . 12₅.

Just below the partition flange 58, there is a lower cooling gas passage 60′ between the lower annular main supply channel 52′ and the lower annular main distribution channel 54′. Through this lower cooling gas passage 60′, the cooling gas enters into the lower annular main distribution channel 54′. Via at least one cooling gas supply channel 62₅ . . . 62₈ in its rabble arm fixing node 28₅ . . . 28₈ each rabble arm cooling system 26′₅ . . . 26′₈ in the lower half of the MHF 10 is in direct communication with the lower annular main distribution channel 54′. Via at least one cooling gas exhaust channel 64₅ . . . 64₈ in its rabble arm fixing node 28₅ . . . 28₈, each rabble arm cooling system 26′₅ . . . 26′₈ in the lower half of the MHF 10 is also in direct communication with the central exhaust channel 56. Consequently, in the rabble arm fixing node 28₅, a secondary cooling gas flow is branched off from the main cooling gas flow in the lower main distribution channel 54′ and rerouted through the rabble arm cooling system 26′₅ to be thereafter directly evacuated into the central exhaust channel 56. In the rabble arm fixing node 28₆, another part of the gas flow in the annular main distribution channel 54′ passes through the rabble arm cooling system 26′₆ and is thereafter also evacuated into the central exhaust channel 56. Finally, in the last rabble arm fixing node 28₈, all the remaining gas flow in the lower main distribution channel 54′ passes through the rabble arm cooling system 26′₈ and is thereafter evacuated into the central exhaust channel 56.

The flow system in the upper half of the shaft 20 is very similar to the flow system described above. The upper cooling gas inlet 44″ is directly connected to the upper half 52″ of the annular main supply channel 52. The cooling gas supplied to the upper cooling gas inlet 44″ consequently enters into the upper annular main supply channel 52″ above the uppermost hearth chamber 12₁ and is then channeled through the latter down to the partition flange 58 between hearth chambers 12₄ and 12₅, wherein the flow rate of the cooling gas remains unchanged over the whole length of the upper annular main supply channel 52″. This constant flow rate of cooling gas over the whole length of the upper annular main supply channel 52′ warrants that the outer shell 50 of the shaft 20 is efficiently cooled in the four upper hearth chambers 12₁ . . . 12₄.

Just above the partition flange 58, there is an upper cooling gas passage 60″ between the upper main supply channel 52″ and the upper annular main distribution channel 54″. Through this upper cooling gas passage 60″, the cooling gas enters into the upper main distribution channel 54″. The connection of each rabble arm cooling system 26′₄ . . . 26′₁ in the upper half of the furnace 10 to the upper main distribution channel 54″ and the central exhaust channel 56 is as described above for rabble arm cooling systems 26′₄ . . . 26′₁ in the lower half. Consequently, in the rabble arm fixing node 28₄, a secondary cooling gas flow is branched off from the main cooling gas flow in the upper main distribution channel 54″ and rerouted through the rabble arm cooling system 26′₄ to be thereafter directly evacuated into the central exhaust channel 56. In the rabble arm fixing node 28₃ another part of the gas flow in the upper main distribution channel 54″ passes through the rabble arm cooling system 26′₃ and is thereafter also evacuated into the central exhaust channel 56. Finally, in the uppermost rabble arm fixing node 28₁ all the remaining gas flow in the upper main distribution channel 54″ passes through the rabble arm cooling system 26′₁ and is thereafter evacuated into the central exhaust channel 56. From the central exhaust channel 56 the exhaust gas stream is then either directly evacuated into the atmosphere or evacuated by means of a rotary connection into a pipe for a controlled evacuation of the gas (not shown).

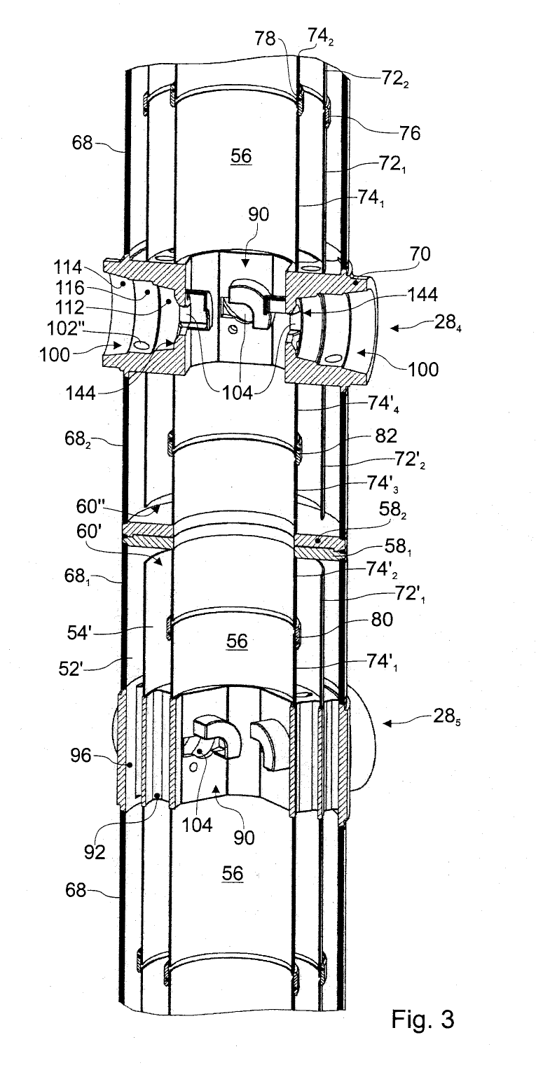

FIG. 3 illustrates a particularly advantageous embodiment of the rotary hollow shaft 20 of the furnace. This FIG. 3 shows more particularly a longitudinal section through the central part of shaft 20. This central part includes the aforementioned partition flange 58, which partitions the annular main supply channel 52 and the annular main distribution channel 54 in a lower half 52′, 54′ and an upper half 52″, 54″.

The outer shell 50 of the shaft consists mainly of intermediate support tubes 68 interconnected by the rabble arm fixing node 28. Such a rabble arm fixing node 28 comprises a ring-shaped cast body 70 made of refractory steel. The intermediate support tubes 68 are made of thick walled stainless steel tubes and are dimensioned as structural load carrying members between successive rabble arm fixing nodes 28. The intermediate support tubes 68 interconnected by massive rabble arm fixing nodes 28 constitute the load bearing structure of the shaft 20, which supports the rabble arms 26 and allows to absorb important torques when the rabble arms 26 are pushing the material over the hearths 14. It will further be noted that—in contrast to prior art shafts—the outer shell 50 described herein is advantageously a welded structure, the ends of the intermediate support tubes 68 are welded to the rabble arm fixing nodes 28, instead of being flanged thereon.

As explained above, the section of the shaft extending between adjacent hearth chambers 12₄ and 12₅ (i.e. the central shaft section) is rather particular because it comprises the partitioning flange 58, as well as the cooling passages 60′, 60″ between the annular main supply channel 52 and the annular main distribution channel 54. Before describing this particular central shaft section, a “normal” shaft section will now be described, also with reference to FIG. 3. Such a “normal” shaft section extending between two other adjacent hearth chambers, as e.g. hearth chambers 12₃ and 12₄, comprises the intermediate support tube 68 welded between two arm fixing nodes 28₃ and 28₄ to form the outer shell 50 of the shaft 20. The intermediate support tube 68 also delimits the annular main supply channel 52 to the outside, which warrants a very good cooling of the intermediate support tube 68. An intermediate gas guiding jacket 72 is arranged within the intermediate support tube 68 so as to delimit the annular main supply 52 channel to the inside and the annular main distribution channel 54 to the outside. An inner gas guiding jacket 74 is arranged within the intermediate gas guiding jacket 72 so as to delimit the annular main distribution channel 54 to the inside and the central exhaust channel 56 to the outside. The intermediate gas guiding jacket 72 comprises a first tube section 72₁ and a second tube section 72₂. The first tube section 72₁ is welded with one end to the fixing node 28₄. The second tube section 72₂ is similarly welded with one end to the fixing node 28₃ (not shown in FIG. 3). The first tube section 72₁ and the second tube section 72₂ have opposite free ends that are arranged opposite one another. A sealing sleeve 76 is fixed to the free end of first tube section 72₁ and sealingly engaging the free end of the second tube section 72₂, while simultaneously tolerating relative movement of both tube sections 72₁ and 72₂ in the axial direction. It follows that an expansion joint is formed in the intermediate gas guiding jacket 72. This expansion joint allows to compensate for differences in thermal expansion of the intermediate support tube 68 and the intermediate gas guiding jacket 72, because the latter remains generally cooler than the intermediate support tube 68. The inner gas guiding jacket 74 similarly comprises a first tube section 74₁ and a second tube section 74₂. The first tube section 74₁ is welded with one end to the fixing node 28₄. The second tube section 74₂ is similarly welded with one end to the fixing node 28₃ (not shown in FIG. 3). The first tube section 74₁ and the second tube section 74₂ have opposite free ends that are arranged in opposite one another. A sealing sleeve 78 is fixed to the free end of first tube section 74₁ and sealingly engaging the free end of the second tube section 74₂, while tolerating relative movement of both tube sections 74₁ and 74₂ in the axial direction. It follows that an expansion joint is formed in the inner gas guiding jacket 74. This expansion joint allows to compensate for differences in thermal expansion of the intermediate support tube 68 and the inner gas guiding jacket 74, which remains generally cooler than the intermediate support tube 68. It will furthermore be appreciated that the solution with the two sealing sleeves 76, 78 renders assembling by welding of the shaft sections much easier.

As can be seen in FIG. 3, the section of the shaft extending between adjacent hearth chambers 12₄ and 12₅ distinguishes from the “normal” section described in the preceding paragraph by several features. The intermediate support tube 68 consists e.g. of two halves 68₁ and 68₂ that are assembled at the level of the partition flange 58 (in fact, each tube half 68₁ and 68₂ includes a terminal ring flange 58₁ and 58₂ and both ring flanges 58₁ and 58₂ are welded together). The intermediate jacket 72′ simply consists of two tube sections 72′₁ and 72′₂, wherein a first end of each tube section 72′₁ and 72′₂ is welded to one of both arm fixing nodes 28₃ and 28₄, and the second end is a free end spaced apart from the partitioning flange 58 to define the gas passages 60′ and 60″ between the lower annular main supply channel 52′ and the lower annular main distribution channel 54′, respectively the upper annular main supply channel 52″ and the upper annular main distribution channel 54″. The inner jacket 74′ consists of four tube sections 74′₁, 74′₂, 74′₁, 74′₂, wherein the first tube section 74′₁ is welded with one end to the arm fixing node 28₄, the second tube section 74′₂ is welded with one end to the flange 58₁, the third tube section 74′₃ is welded with one end to the flange 58₂ and the fourth tube section 74′₄ is welded with one end to the arm fixing node 28₃. A first sealing sleeves 80 provides a sealed connection and axial expansion joint between the opposite free ends of the first tube section 74′₁ and the second tube section 74′₂. A second sealing sleeves 82 provides a sealed connection and axial expansion joint between the opposite free ends of the third tube section 74′₃ and the fourth tube section 74′₄. The sealing sleeves 80 and 82 just work as the sealing sleeves 76 and 78 and render assembling of the central shaft section much easier.

To complete thermal protection of the shaft 20, the latter is advantageously recovered with a thermal insulation (not shown). Such an insulation of the shaft 20 is advantageously a multilayer insulation including e.g. an inner refractory layer of micro-porous material, a thicker intermediate refractory layer of insulating castable material and an even thicker outer refractory layer of dense castable material.

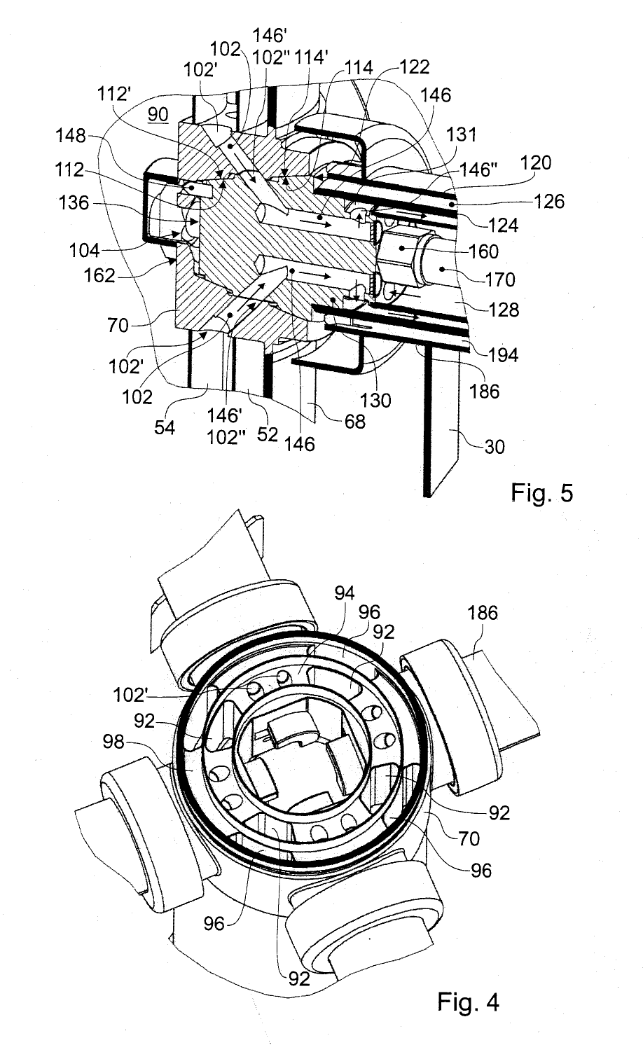

A preferred embodiment of a rabble arm fixing node 28 is now describe with reference to FIG. 3 and FIG. 4. As said already above, the rabble arm fixing node 28 comprises a ring-shaped cast body 70 made of refractory steel. The central passage 90 in this ring shaped body 70 forms the central exhaust channel 56 for the cooling gas within the rabble arm fixing node 28. First secondary passages 92 are arranged in a first ring section 94 of the ring shaped body 70 around the central passage 90, so as to provide gas passages for cooling gas flowing through the annular main distributi0on channel 54. Second secondary passages 96 are arranged in a second ring section 98 of the ring shaped body 70 around the first ring section 94, so as to provide gas passages for cooling gas flowing through the annular main supply channel 52. For each rabble arm 26 to be connected to rabble arm fixing node 28, the ring shaped body 70 includes furthermore a socket 100, i.e. a cavity extending radially into the ring shaped body 70 between the aforementioned first and second secondary passages 92 and 96. The rabble arm fixing node 28 includes four sockets 100, wherein the angle between the central axis of two consecutive sockets 100 is 90°. Oblique bores 102 in the ring shaped body 70 (see FIG. 5), which have an inlet opening 102′ in the second ring section 98 of the ring shaped body 70 and an outlet opening 102″ in a lateral surface of the socket 100, form the cooling gas supply channels 62, which have already been mentioned within the context of the description of FIG. 3. A through hole 104 in the ring shaped body 70, in axial extension of the socket 100, forms the cooling gas return channel 64, which has already been mentioned within the context of the description of FIG. 3.

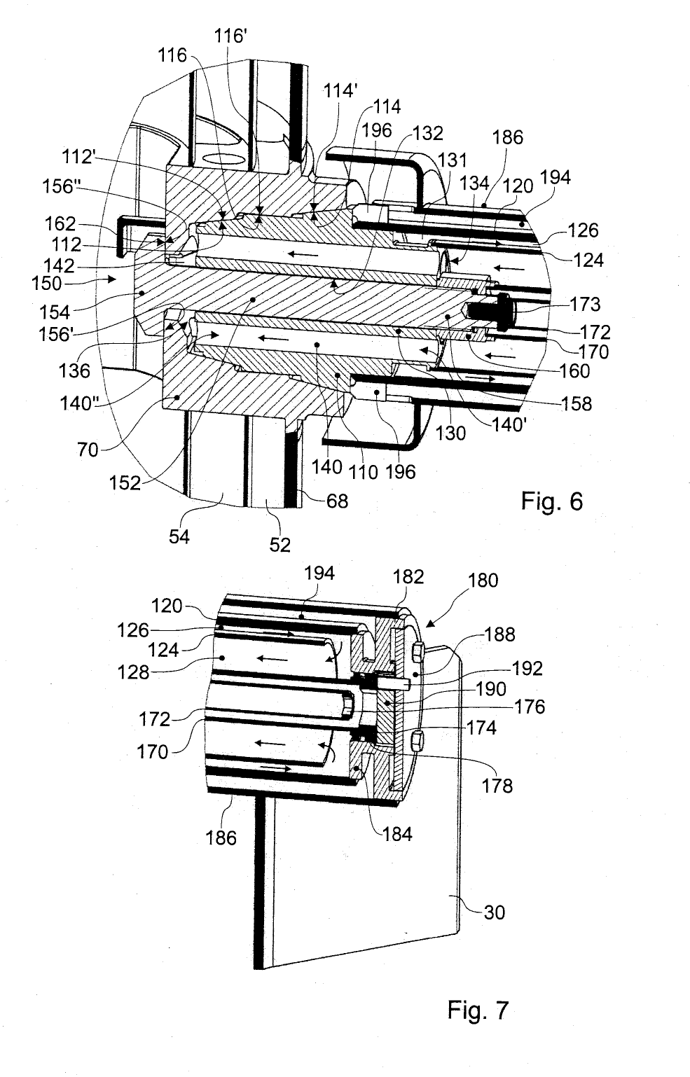

Considering now more particularly FIG. 3, FIG. 5 and FIG. 6, it will first be noted that the rabble arm 26 includes a plug body 110 that form a coupling end of the rabble arm 26 received in the socket 100 of the rabble arm fixing node 28 (see FIGS. 3 &5). The plug body 110 is cast solid body with several bores therein, which is advantageously made of refractory steel. The socket 100 has therein two concave conical seat surfaces 112, 114 separated by a concave cylindrical guiding surface 116. The plug body 110 has thereon two convex conical counter-seat surfaces 112′, 114′ separated by a convex cylindrical guiding surface 116′. All these conical surface 112, 114, 112′, 114′ are ring surfaces of a single cone, i.e. have the same cone angle. This cone angle should normally be greater than 10° and smaller than 30° and is normally within the range of 18° to 22°. When the plug body 110 is axially inserted into the socket 100, the convex conical counter-seat surface 112′ is pressed against the concave conical seat surface 112 and the convex conical counter-seat surfaces 114′ is pressed against the concave conical seat surfaces 114.

When securing a new rabble arm 26 to the shaft 20, the plug body 110 of the rabble arm 26 has to be introduced into the socket 100 of the rabble arm fixing nod 110. During this introduction movement, the outer concave conical seat surface 114 first guides the plug body 110 into axial alignment with the cylindrical guiding surface 116. Thereafter both cylindrical guiding surfaces 116 and 116′ cooperate with one another for axially guiding the plug body 110 into its final seat position in the socket 100. It will be appreciated that axial guidance provided by the two cylindrical guiding surfaces 116 and 116′ considerably reduces the risk of damaging the plug body 110 or the socket 100 during the final coupling operation.

The rabble arm 26 further comprises an arm support tube 120 welded with one end to a shoulder surface 122 on the rear side of the plug body 110. This arm support tube 120 has to withstand the forces and torques acting on the rabble arm. It advantageously consists of a thick walled stainless steel tube extending over the whole length of the rabble arm 26. A gas guiding tube 124 is arranged inside the arm support tube 122 and cooperates with the latter to define between them a small annular cooling gap 126 for channeling the cooling gas to the free end of the rabble arm 26. The interior section of the gas guiding tube 124 forms a central return channel 128 through which the cooling gas flows back from the free end of the rabble arm 26 to the plug body 110.

It will be noted that one end of the gas guiding tube 124 is welded to a cylindrical extension 130 on the rear side of the plug body 110. The diameter of this cylindrical extension is smaller than the internal diameter of the arm support tube 120, so that an annular chamber 131 remains between the cylindrical extension 130 and the arm support tube 120 surrounding the cylindrical extension 130. This annular chamber 131 is in direct communication with the small annular cooling gap 126 between the gas guiding tube 124 and the arm support tube 122.

As already explained above, the plug body 110 is a solid cast body comprising several bores that will now be described. In FIG. 6, reference number 132 identifies an central hole extending axially through the plug body 110, from an end face 134 on the cylindrical extension 130 to a front face 136 on the front end of the plug body 110. The purpose of this central hole 132 will be described later. Reference number 140 in FIG. 6 identifies gas return bores arranged in the plug body 110 around the central hole 132 and having inlet openings 140′ in the end face 134 and outlet openings 140″ in the front face 136 of the plug body 110 (there are four of such gas return bores 140 arranged around the central hole 132). These gas return bores 140 form communication channels between the return channel 128 in the rabble arm 26 and a gas outlet chamber 142 remaining in the socket 100 between the front face 136 of the plug body 110 and a bottom surface 144 of the socket 100 when the plug body 110 is seated therein. From this gas outlet chamber 142, the cooling gas returning from the rabble arm 26 overflows through the through hole 104 into the central passage 90 of the rabble arm fixing node 28, i.e. into the central exhaust channel 56 of the shaft 20. Reference number 146 in FIG. 5 identifies four gas supply bores arranged in the plug body 110. These gas supply bores 146 have inlet openings 146′ in the convex cylindrical guiding surface 116′ of the plug body 110 and outlet openings 146″ in the cylindrical surface of the cylindrical extension 130. It will be noted that the inlet openings 146′ in the convex cylindrical guiding surface 116′ are overlapping with the gas outlet openings 102″ of the oblique bores 102 in the ring shaped body 70. It is recalled in this context that these oblique bores 102 form the cooling gas supply channels 62 for the rabble arm 26 in the rabble arm fixing node 28. Consequently, when the plug body 110 is seated in its socket 100, the gas supply bores 146 form communication channels in the plug body 110 between the annular chamber 131, which is in direct communication with the small annular cooling gap 126 in the rabble arm 26, and the cooling gas supply for the rabble arm 26 in the rabble arm fixing node 28. It will be appreciated that a positioning pin 148 in the front end of the plug body 110 co-operates with a positioning bore in the bottom surface 144 of the socket 100 to warrant an angular alignment of the inlet openings 146′ in the convex cylindrical guiding surface 116′ of the plug body 110 with the gas outlet openings 102″ in the concave cylindrical guiding surface 116 in the socket 100 when the plug body 110 is inserted into the socket 100. For sealing off the gas passages between the rabble arm fixing node 28 and the plug body 110 in the socket 100, the convex conical counter-seat surfaces 112′, 114′ of the plug body 110 are advantageously equipped with one or more temperature resistant seal rings (not shown). Furthermore, for improving the sealing function of the convex conical counter-seat surfaces 112′, 114′ in the socket 100, the latter are advantageously recovered with a temperature resistant sealing paste.

Referring now to FIG. 6, novel preferred securing means for securing the plug body 110 in its socket 100 will be described. This novel securing means comprises a clamping bolt 150. The latter comprises a cylindrical bolt shank 152 loosely fitted in the central hole 132 of the plug body 110. This bolt shank 152 supports on the front side of the plug body 110 a bolt head 154, which advantageously has the form of a hammer head defining a shoulder surface 156′, 156″ on each side of the shank 152. On the rear side of the plug body 110, the bolt shank 152 has a threaded bolt end 158. The preferred securing means shown in FIG. 6 further comprises a threaded sleeve 160 (or a standard nut) that is screwed onto the threaded bolt end 158 protruding out of the central hole 132 of the plug body 110 on the rear side of the latter.

FIG. 6 shows the axial clamping device in a clamping position in which it firmly presses the plug body 110 into the socket 100. In this clamping position the threaded sleeve 160 bears against an abutment surface on the rear side of the plug body 110. This abutment surface corresponds e.g. to the end surface 134 of the cylindrical extension 130 of the plug body 110. On the other side of the plug body 110, the bolt shank 152 extends through the gas outlet chamber 142 and the through hole 104 in the bottom of the socket 104 into the central passage 90 of the rabble arm fixing node 28. Here, the hammer head 154 of the bolt 150 is in hooking engagement with an abutment surface 162 in the arm fixing node 28, wherein its two shoulder surface 156′, 156″ bear against the abutment surface 162. It will be appreciated that the clamping bolt 150 is sufficiently preloaded, i.e. the threaded sleeve 160 is tightened with a predetermined torque, to warrant that the plug body 110 is always firmly pressed into the socket 100 during operation of the MHF.

When one of the rabble arms 26 is dismounted, the clamping bolt 150 is extracted with rabble arm 26, i.e. it remains in the plug body 110 of the rabble arm 26. In order to be able to extract the hammer head 154 through the through hole 104 in the bottom of the socket 100, this through hole has the form of a key hole having a form corresponding roughly to the cross-section of the hammer head 154. It follows that by rotating the hammer head 154 by 90° about the central axis of the bolt shank 152, the hammer head 154 can be brought from the “hooked position” shown in FIG. 6”, into an “unhooked position”, in which it can be axially extracted through the keyhole 104 into the socket 100. Similarly, when a new rabble arm 26 is mounted, the hammer head 154 is first in a position in which it can axially pass through the key hole 104. Once the plug body 110 is seated in its socket 100, the hammer head 154, which is now located on the other side of key hole 104, can be brought into the “hooked position” shown in FIG. 6 by rotating the hammer head 154 by 90° about the central axis of the bolt shank 152. It will further be appreciated that in the “hooked position” of the clamping bolt 150 shown in FIG. 6, the hammer head 154 leaves a quite large outlet opening for the cooling gas flowing through the through hole 104 into the central gas passage 90.

The clamping device shown in FIG. 6 also comprises actuation and positioning means for tightening/losing and positioning it from a safe position outside the MHF. This actuation means will now be described with reference to FIG. 6 and FIG. 7. In FIG. 6, reference number 170 identifies an actuation tube that is secured (e.g. welded) with one end to the threaded sleeve 160. Reference number 172 identifies a positioning tube that is secured with one end to the bolt shank 152 (e.g. by means of a bolt 173 welded to the rear end of the positioning tube 172 as shown in FIG. 6). Referring now to FIG. 7, it will be seen that both the actuation tube 170 and the positioning tube 172 axially extend through the intermediate support tube 120 up to the free end of the latter. Here, both the front end of the actuation tube 170 and the front end of the positioning tube 172 include a coupling head 174, 176 for coupling thereto an actuation key (not shown). Both coupling heads 174, 176 may e.g. include a hexagonal socket as shown in FIG. 7. The coupling head 174 of the actuation tube 170 is rotatably supported in a central through-hole 178 of an end-cup 180 and sealed within this through-hole 178. The end-cup 180 comprises on its rear side a first flange 182 closing the front end of the intermediate support tube 120 and on its front side a second flange 184 closing the front end of an outer metallic protecting jacket 186, which will be described later. The positioning tube 172 is rotatably supported with the actuation tube 170. A blind flange 188 is flanged on the front face of the second flange 184 of the end-cup 180, so as to close the central through-hole 178 in the end-cup 180. A thermally insulating plug is inserted between the coupling head 174 and the blind flange 188. Reference number 192 identifies a positioning pin fixed to the blind flange 188. This positioning pin 192 extends through the insulating plug 190 to bear with one end onto the coupling head 174, thereby avoiding a loosening of the threaded sleeve 160.

After removing the blind flange 188 and the thermally insulating plug 190, one has access to the coupling heads 174, 176 of the actuation tube 170 and the positioning tube 172. The actuation tube 170 is used to tighten the threaded sleeve 160. The positioning tube 172 mainly serves as an indicator of the position the hammer head 154 has with regard to the key-hole 104. Its coupling head 176 is therefore provided with an adequate positioning mark. It will be noted that the positioning tube 172 may also be used for fixing the clamping bolt 150 while loosening the threaded sleeve 160 by means of the actuation tube 170. Finally, the coupling head 174 of the actuation tube 170 may also have marks thereon, which in combination with the marks on the coupling head 176 of the positioning tube allow to check whether a sufficient tightening torque has been applied to the clamping device. It remains to be noted that the blind flange 188 may be removed during operation of the cooling system without a substantial gas leakages. Indeed, the threaded sleeve 160 seals the rear end of the actuation tube 170 and the front end of the actuation tube is sealed within the central through-hole 178 in the end-cup 180.

The aforementioned metallic protecting jacket 186, which is seen on FIGS. 4 to 7, recovers a micro porous thermal insulation layer 194 arranged on the intermediate support tube 120. Anti-rotating means, as e.g. identified with reference number 196 in FIG. 6, interconnect the metallic protecting jacket 186 and the intermediate support tube 120 and avoid any rotation of the protecting jacket 186 about the central axis of the rabble arm 26. It will be appreciated that in a preferred embodiment of the rabble arm 26, the protecting jacket 186 is made of stainless steel, wherein the rabble teeth 30, which are also are made of stainless steel, are welded directly onto the protecting jacket 186 (see e.g. FIG. 7, showing one of these rabble teeth 70).

1.-20. (canceled)

21. A multiple hearth furnace comprising:
a plurality of hearth chambers arranged one on top of the other;
a hollow vertical rotary shaft extending centrally through said hearth chambers, said shaft including an outer shell;
in each of said hearth chambers at least one rabble arm secured to said shaft;
a gas cooling system for said shaft and said rabble arms, said gas cooling system including within said outer shell an annular main distribution channel for supplying a cooling gas to said rabble arms and a central exhaust channel for evacuating the cooling gas leaving said rabble arms; and
connecting means for connecting said rabble arms to said shaft, each of said connecting means including cooling gas supply means in direct communication with said annular main distribution channel and cooling gas return means in direct communication with said central exhaust channel;
wherein said gas cooling system further comprises:
an annular main supply channel surrounding said annular main distribution channel and being outwardly delimited by said outer shell;
a cooling gas inlet connected to said annular main supply channel; and
a cooling gas passage between said annular main supply channel and said annular main distribution channel, said cooling gas passage being spaced from said cooling gas inlet, so that cooling gas supplied to said cooling gas inlet has to flow through said annular main supply channel through several hearth chambers before it flows through said cooling gas passage into said annular main distribution channel.

22. The furnace as claimed in claim 21, wherein said gas cooling system comprises:
partition means partitioning said annular main supply channel and said annular main distribution channel in a lower half and an upper half;
a lower cooling gas inlet connected to said lower half of said annular main supply channel at the lower end of said shaft;
an upper cooling gas inlet connected to said upper half of said annular main supply channel at the upper end of said shaft;
a lower cooling gas passage between said lower half of said annular main supply channel and said lower half of said annular main distribution channel, said lower cooling gas passage being located near said partition means, so that cooling gas supplied to said lower cooling gas inlet has to flow upwards though said lower half of said annular main supply channel up to said partition means before it can flow through said lower cooling gas passage into said lower half of said annular main distribution channel; and
an upper cooling gas passage between said upper half of said annular main supply channel and said upper half of said annular main distribution channel, said second cooling gas passage being located near said partition means, so that cooling gas supplied to said upper cooling gas inlet has to flow downwards though said upper half of said annular main supply channel down to said partition means before it can flow through said second cooling gas passage into said upper half of said annular main distribution channel.

23. The furnace as claimed in claim 21, wherein said outer shell comprises:
shaft support tubes and cast rabble arm fixing nodes interconnecting said shaft support tubes, wherein at least one rabble arm is fixed to each of said rabble arm fixing nodes.

24. The furnace as claimed in claim 23, wherein:
said rabble arm fixing node and said shaft support tubes are welded together.

25. The furnace as claimed in claim 24, wherein:
said shaft support tubes are made of thick walled stainless steel tubes and are dimensioned as structural load carrying members between said rabble arm fixing nodes.

26. The furnace as claimed in claim 25, wherein at least one of said rabble arm fixing nodes comprises a ring-shaped cast body made of refractory steel.

27. The furnace as claimed in claim 23, wherein at least one of said rabble arm fixing nodes comprises a ring-shaped cast body made of refractory steel.

28. The furnace as claimed in claim 27, wherein at least one rabble arm includes:
a tubular structure for circulating therethrough a cooling gas; and
plug body connected to said tubular structure of the rabble arm received in a socket on said vertical rotary shaft.

29. The furnace as claimed in claim 28, wherein at least one of said rabble arm fixing nodes comprises a ring-shaped cast body including:
at least one socket for receiving therein said plug body of said rabble arm;
a central passage forming said central exhaust channel for the cooling gas within said rabble arm fixing node;
first secondary passages arranged in a first ring section of said cast body, so as to provide gas passages for cooling gas flowing through said annular main distribution channel;
second secondary passages arranged in a second ring section of said cast body, so as to provide gas passages for cooling gas flowing through said annular main supply channel;
said cooling gas supply means being arranged in said cast body so as to interconnect the annular main supply channel with at least one gas outlet opening within said socket; and
said cooling gas return means being arranged in said cast body so as to interconnect the central passage with at least one gas inlet opening within said socket.

30. The furnace as claimed in claim 29, wherein:
said cooling gas return means comprises a through hole in axial extension of said socket.

31. The furnace as claimed in claim 28, wherein:
said cooling gas supply means comprises at least one oblique bore extending through said ring-shaped cast body from said second ring section into a lateral surface delimiting said socket.

32. The furnace as claimed in claim 21, wherein at least one section of said shaft extending between two adjacent hearth chambers comprises:
a shaft support tube arranged between two arm fixing nodes to form the outer shell of said section of said shaft, said shaft support tube delimiting said annular main supply channel to the outside;
an intermediate gas guiding jacket arranged within said shaft support tube so as to delimit said annular main supply channel to the inside and said annular main distribution channel to the outside; and
an inner gas guiding jacket arranged within said intermediate gas guiding jacket so as to delimit said annular main distribution channel to the inside and said central exhaust channel to the outside.

33. The furnace as claimed in claim 32, wherein said intermediate gas guiding jacket comprises:
a first tube section with a first end fixed to said first fixing node and a free second end;
a second tube section with a first end fixed to said second fixing node and a free second end;
a sealing means providing a sealed connection between the free second end of said first tube section and the free second end of said second tube section, while tolerating relative movement in the axial direction of both free second ends.

34. The furnace as claimed in claim 33, wherein said sealing means comprises:
a sealing sleeve fixed to the free second end of one of said first or second tube sections and engaging in a sealed manner the free second end of the other tube section.

35. The furnace as claimed in claim 32, wherein said inner gas guiding jacket comprises:
a first tube section with a first end fixed to said first fixing node and a free second end;
a second tube section with a first end fixed to said second fixing node and a free second end;
a sealing means providing a sealed connection between the free second end of said first tube section and the free second end of said second tube section, while tolerating relative movement in the axial direction of both free second ends.

36. The furnace as claimed in claim 35, wherein said sealing means comprises:
a sealing sleeve fixed to the free second end of one of said first or second tube sections and engaging in a sealed manner the free second end of the other tube section.

37. The furnace as claimed in claim 21, wherein said rotary hollow shaft further comprises:
an outer thermal insulation on its outer shell, said outer thermal insulation including an inner refractory layer of micro porous material, an intermediate refractory layer of insulating castable material and an outer refractory layer of dense castable material.

38. The furnace as claimed in claim 21, wherein at least one of said rabble arms comprises:
a plug body for fixing said rabble arm to said rotary hollow shaft;
an arm support tube fixed to said plug body; and
a gas guiding tube arranged inside said arm support tube and cooperating with the latter to define between them a small annular gap for channeling the cooling gas from the shaft to the free end of the rabble arm, wherein the interior section of the gas guiding tube forms a return channel for the cooling gas from the free end of the rabble arm to the shaft.

39. The furnace as claimed in claim 38, wherein said plug body is a solid cast body including at least one cooling gas supply channel and at least one cooling gas return channel.

40. The furnace as claimed in claim 39, wherein said at least one cooling gas supply channel and said at least one cooling gas return channel are provided as bores in said solid cast body.

41. The furnace as claimed in claim 21, wherein at least one of said rabble arms further comprises:
an arm supporting tube;
a micro porous thermal insulation layer arranged on said arm supporting tube; and
a metallic protecting jacket covering said micro porous thermal insulation layer.

42. The furnace as claimed in claim 41, wherein said rabble arm further comprises:
metallic rabble teeth fixed to said metallic protecting jacket by welding; and
anti-rotation means arranged between said arm supporting tube and said metallic protecting jacket.
